(19) United States
(12) Patent Application Publication
(10) Pub. No.: US 2011/0320537 A1
(43) Pub. Date: Dec. 29, 2011

(54) One-way information transfer for performing secure information updates

(75) Inventor: Shawn G. Abigail, Ottawa (CA)

(73) Assignee: Alcatel-Lucent Canada

(21) Appl. No.: 12/803,322

(22) Filed: Jun. 24, 2010

(51) Int. Cl. G06F 15/16

(52) U.S. Cl. 709/206; 709/204

(57) ABSTRACT

A server comprises one or more data processing device, instructions processable by the one or more data processing device, and an apparatus from which the instructions are accessible by the one or more data processing device. The instructions are configured for causing the one or more data processing device to receive an information update command from a system user, access an information update rule corresponding to the information update command, and perform unidirectional transmission of information to at least one secure information system for causing at least one update action defined by the information update rule to be implemented by the at least one secure information system.

### FIELD OF THE DISCLOSURE

The disclosures made herein relate generally to computer network systems and, more particularly, to using a computer network system for implementing one-way information transfer to perform secure information updates.

### BACKGROUND

Information systems through which a person manipulates information within a computer network are well known. Examples of such information system include, but are not limited to, a calendar server, an e-mail server, a web server, a telecomm server, and the like. These information systems can require that such information updates be made through a secure interface. In this manner, the information systems can be secure information systems. In situations where this information update is performed in a secure manner, information transfer is often implemented by an information system in a two-way manner. For example, upon authentication of a system user, the information system can allow information to be provided therefrom to the authenticated user and from the authenticated user to the information system.

In many instances, a person is in a situation where they need to make information updates on a secure information system, but they are without access to a secure interface through which access to the secure information system can be provided. For example, a person may be away from their office and not have access to a secure information system through which they can determine if they have any meetings scheduled during a particular time period. In the case where they do have a meeting scheduled during that particular time period, the person wants to inform the attendees of that meeting that he or she will be late by a certain amount of time. One current solution to this problem is for the person to contact and ask another person having access to the secure information system (e.g., a co-worker) to access the secure information system and inform the attendees of that meeting that the person will be late by the certain amount of time (i.e., an information update for notification of delay).

Existing solution to the problem of performing an information update via a secure information system when access to that secure information system is not possible are undesirable for many reasons. Examples of these reasons include, but are not limited to, assuming that a coworker can be reached, assuming that a coworker has time available to inform others, assuming a coworker has access to the required information system(s), encouraging the sharing of passwords, and being unprofessional for a person to ask a coworkers to assist with such a task. This being the case, a person needing to make an information update on a secure information system will find it beneficial to have access to a mechanism that allows them at least limited access to the secure information system for making certain information updates when they are unable to have full access to such secure information system.

### SUMMARY OF THE DISCLOSURE

Embodiments of the present invention provide a system user with limited access to a secure information system for making certain information updates when they do not have full access to such secure information system (e.g., through a system-provided secure interface). More specifically, embodiments of the present invention allow the user to implement one-way information transfer with a secure information system for performing secure information updates through such secure information system. One-way information transfer refers to update information being provided to the secure information system without the transfer of information from the secure information system to a device being used by a system user to request such information update. In this manner, embodiments of the present invention advantageously overcomes one or more shortcomings associated with conventional approaches for making information updates on a secure information system when access to a secure interface through which access to the secure information system is not available.

In one embodiment of the present invention, a server comprises at least one data processing device, instructions processable by the at least one data processing device, and an apparatus from which the instructions are accessible by the at least one data processing device. The instructions are configured for causing the at least one data processing device to receive an information update command from a system user, access an information update rule corresponding to the information update command, and perform unidirectional transmission of information to at least one secure information system for causing at least one update action defined by the information update rule to be implemented by the at least one secure information system.

In another embodiment of the present invention, a computer-readable medium having tangibly embodied thereon and accessible therefrom a set of instructions interpretable by at least one data processing device. The set of instructions is configured for causing the at least one data processing device to carry out operations for receiving an information update command from system user, accessing an information update rule corresponding to the information update command, accessing at least one secure information system on which the system user has an account; and causing at least one update action defined by the information update rule to be implemented by the at least one secure information system.

In another embodiment of the present invention, a method comprises instructions accessible from memory and configured for causing at least one data processing device to perform a plurality of operations. The instructions are configured for causing the at least one data processing device to receive an information update command from a system user after passcode information of the system user is successfully verified. The instructions are configured for causing the at least one data processing device to access an information update rule corresponding to the information update command. The information update rule defines at least one update action. The instructions are configured for causing the at least one data processing device to access at least one secure information system on which the system user has an account. The instructions are configured for causing the at least one data processing device to cause the at least one update action defined by the information update rule to be implemented by the at least one secure information system.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a flow chart showing a method configured to implement information transfer for performing secure information updates in accordance with an embodiment of the present invention.

FIG. 2 is a diagrammatic view showing a system configured in accordance with an embodiment of the present invention to implement information transfer for performing secure information updates.

### DETAILED DESCRIPTION OF THE DRAWING FIGURES

Embodiments of the present invention provide an interface that can receive an information update command (i.e., a request for a certain information update action(s)) from non-secure access methods (e.g. cell phone or web browser) and pass along corresponding information update actions. Preferably, the information update actions are defined by a corresponding information update rule and are transmitted for reception by one or more information systems in a one-way direction (i.e., toward secure information systems on which information updates are implemented). By providing the information update command using a non-secure access mechanism (e.g., via cell phone, laptop, etc), a user would not need to have a full system mandated (e.g., corporate network) security mechanisms available. In this manner, the embodiments of the present invention provide a convenient and practical means for providing a system user with limited access to a secure information system for making certain information updates when they do not have full access to such secure information system. For example, a system user may have a laptop and secure token generator in its possession, but may not be able to start the laptop in traffic and/or may not have public network (e.g., Internet) access. Likewise, a user may be home but has left his computer laptop at home.

It is disclosed herein that reference herein to a non-secure access mechanism does not necessarily mean that there is a complete absence of security. There can still be some sort of password or other authentication mechanism in use for authenticating or verifying a system user prior to allowing them to initiate an information update. While such a password or other authentication mechanism would allow for limited access to a secure information system for making certain information updates when the system user does not have full access to such secure information system, the password or other authentication mechanism may not be a full system-mandated security mechanism that enables 2-way information flow between the secure information system and an access mechanism of the system user.

Preferably, where the access mechanism is a non-secure access mechanism, 2-way information flow between the secure information system and the non-secure access mechanism is inhibited. By implementing information updates in a one-way direction, the need for a completely secure interface is precluded. One reason for this is that a hacker (i.e., a malicious entity) would not be able to obtain information from the secure information system. Indeed, in some implementations of the present invention, the hacker may not even know what information system (secure or otherwise) a system user was providing updates to. Even if a hacker obtains a system user's password/authentication information, the degree of malicious activity that the hacker can carry out will be limited.

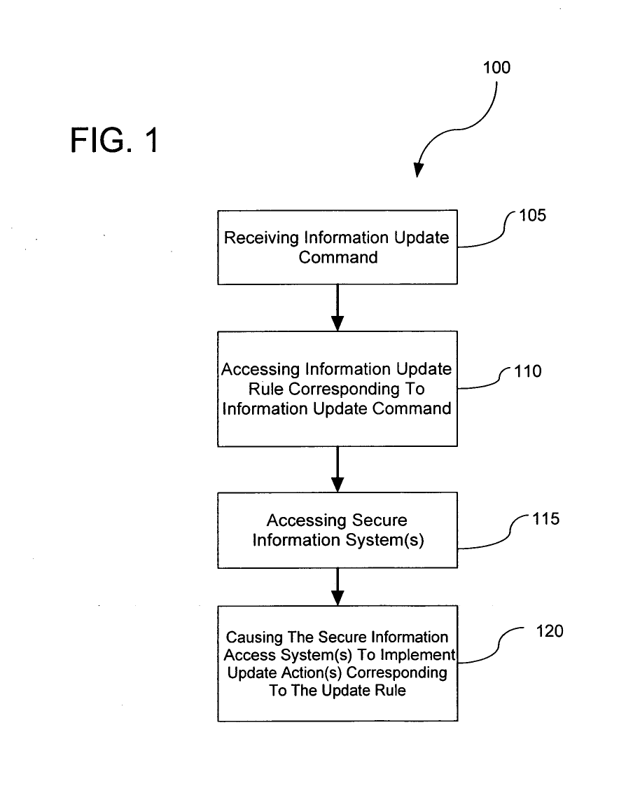

Turning now to FIG. 1, a method 100 configured to implement information transfer for performing secure information updates in accordance with an embodiment of the present invention is shown. Such a method can be carried out by a rules server coupled to one or more secure information servers. The rules server can be coupled to a server configured for authenticating or verifying an identity of system users and/or can be configured with functionality for authenticating or verifying an identity of system users. In this manner, the identity of a system user can be authenticated or verified prior to performing the method 100.

The method 100 begins with an operation 105 being performed for receiving an information update command from a system user having an account on a secure information system. Examples of such an information update command include, but are not limited to, a command relating to the system user being sick, a command relating to the system user working for a prescribed period of time from a remote location from a work environment that the at least one secure information system serves, a command relating to the system user being absent for a prescribed period of time from a work environment that the at least one secure information system serves, a command relating to the system user arriving within a prescribed period of time at the work environment that the at least one secure information system serves, and the like. An operation 110 is then performed for accessing an information update rule corresponding to the information update command. Concurrent with, prior to, and/or after the operation 110 is performed for accessing the information update rule, an operation 115 is performed for accessing one or more secure information systems on which the system user has an account. Examples of such a secure information system include, but are not limited to, an electronic messaging server (e.g., e-mail server), a calendar server, a meeting server, a web server, an integrated applications server (e.g., server providing functionality for electronic messaging, calendaring, etc), a telecommunication server (e.g., a telephony/conferencing server), a voice mail server, etc. In one embodiment, accessing the one or more secure information systems can include the rules server acting as a proxy for the system user thereby performing any necessary authentication and/or verification operations on behalf of the system user.

After the operation 110 is performed for accessing the information update rule and after the operation 115 is performed for accessing the one or more secure information systems, an operation 120 is performed for causing one or more update actions defined by the information update rule to be implemented by the one or more secure information systems. In one embodiment, causing the one or more update actions to be implemented by the one or more secure information systems includes required transmission of data (i.e., instructions corresponding to the update actions) from the rules server to the one or more secure information systems. Update actions are defined herein to be update rule specific. As such, each update rule can define (i.e., have associated therewith) one or more update actions associated therewith. Each one of these different update actions of an information update rule can be configured for being provided to a respective one of a plurality of different secure information systems and each one of the different secure information systems can provide information communication in a different mode of communication (e.g., e-mail, voice, mail, calendaring, etc) than each other one of the secure information systems.

Preferably, but not necessarily, causing the one or more update actions defined by the information update rule to be implemented can include unidirectional transmission of update information (i.e., one-way information transfer) to each one of the one or more secure information systems. In this manner, a single information update action can result in each one of a plurality of different secure information systems carrying out an action specific to a specific functionality thereof (e.g., voice mail server changing a voice mail availability status of the system user and an e-mail server changing an e-mail availability status of the system user). Such unidirectional transmission of update information also provides for security of information in that information managed by the secure information system(s) is not made available to the device or system through which the information update request was initiated.

### Example 1

### Sick Employee Absent from Work

An update rule corresponds to a situation where an employee will be absent from work due to being sick. In this case, a rules server of an employer of the employee can be configured to implement one or more absence-specific update actions in response to receiving an information update command corresponding to an employee being sick. Examples of such update actions include, but are not limited to, sending a message to a calendar server canceling any meetings for which this employee (i.e., system user) is the initiator and/or facilitator, sending a message to the calendar server declining any meetings which this employee had accepted, checking if any meetings are currently in progress, look up the teleconferencing number or voice bridge number and give a standard verbal message that this employee will be unable to attend, changing the employees voice mail to provide an out-of-office alert, changing the employees email to provide an out-of-office alert; and running a script that updates an internal web page to update that employee's status.

### Example 2

### Employee Late for Work

An update rule corresponds to a situation where an employee will be late to work by a prescribed amount of time (e.g., 15-minutes). In this case, a rules server of an employer of the employee can be configured to implement one or more tardiness-specific update actions in response to receiving an information update command corresponding to an employee being late to work by a prescribed amount of time. Examples of such update actions include, but are not limited to, accessing a calendaring server to determine a meeting for which the employee is the initiator and/or facilitator, sending an email to meeting attendees informing them that the employee will be arriving at work in 10 minutes, if it is determined that there is a meeting affected by the employees tardiness, shifting the start of a meeting by 15 minutes, if it is determined that there is a meeting affected by the employees tardiness, sending a late message to meeting attendees of an in-progress meeting over a teleconferencing device in a meeting room for that in-progress meeting, if it is determined that there is a meeting affected by the employees tardiness, and updating a web page with information that a backup contact should be used for support calls for the specified time the employee is tardy.

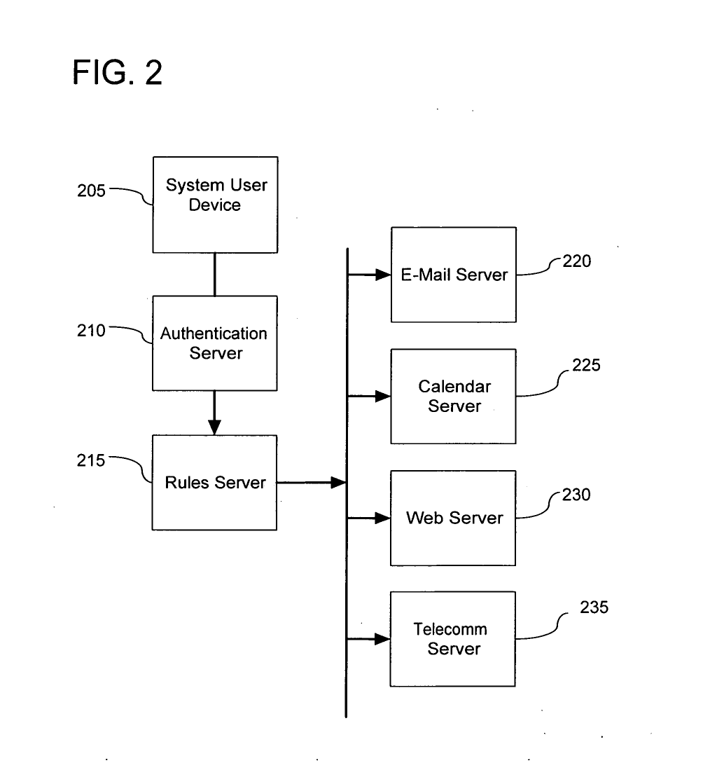

Referring now to FIG. 2, an architecture for a system 200 configured in accordance with an embodiment of the present invention is shown. A system user device 205 (e.g., a cell phone, laptop, PDA, etc) can communicate with an authentication server 210 for authenticating (i.e., verifying) an identity of a person intending to use the system user device 205 to initiate an information update request via issuance of an information update command. The authentication server 210 can be a light-weight authentication server or other type of system configured for verifying or authenticating an identity of a user of a communication device. The authentication server 210 is coupled to a rules server 215, which is configured for implementing information update functionality in accordance with the present invention (e.g., as disclosed above in reference to FIG. 1). The rules server 215 is coupled to an e-mail server 220, a calendar server 225, a web server 230, and a telecomm server 235 (e.g., server configured for providing voice and/or teleconferencing functionality). In this manner, the rules server 215 is coupled between a system configured for verifying or authenticating an identity of a user of a communication device and a plurality of information systems. With such a system architecture, once an information update command is received by the rules server 215 from a verified entity, the rules server 215 can implement one-way information transfer (i.e., transmission of information update actions to one or more of the information systems) for performing secure information updates.

Referring now to instructions processible by a data processing device, it will be understood from the disclosures made herein that methods, processes and/or operations adapted for carrying out information update functionality as disclosed herein are tangibly embodied by computer readable medium having instructions thereon that are configured for carrying out such functionality. In one specific embodiment, the instructions are tangibly embodied for carrying out the method 100 disclosed above. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the presenting invention include a compact disk, a hard drive, RAM or other type of storage apparatus that has imaged thereon a computer program (i.e., instructions) adapted for carrying out information update functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A server, comprising:
at least one data processing device;
instructions processable by said at least one data processing device; and
an apparatus from which said instructions are accessible by said at least one data processing device;
wherein said instructions are configured for causing said at least one data processing device to:
receive an information update command from a system user;
access an information update rule corresponding to the information update command, wherein the information update rule defines at least one update action; and
perform unidirectional transmission of information to at least one secure information system for causing said at least one update action defined by the information update rule to be implemented by said at least one secure information system.

2. The server of claim 1 wherein:
the information update rule defines a plurality of different update actions; and
said instructions causing said at least one data processing device to cause said at least one update action to be implemented includes said instructions causing said at least one data processing device to cause each one of said different update actions to each be implemented by a respective one of a plurality of different secure information systems.

3. The server of claim 2 wherein said instructions causing said at least one data processing device to cause each one of said different update actions to each be implemented by the respective one of a plurality of different secure information systems includes said instructions causing said at least one data processing device to perform unidirectional transmission of information to each one of said different secure information systems.

4. The server of claim 1 wherein the update rule is configured for implementing actions corresponding to one of:
the system user being absent for a prescribed number of days from a work environment that said at least one secure information system serves;
the system user arriving within a prescribed period of time at the work environment that said at least one secure information system serves.

5. The server of claim 1 wherein:
the information update rule defines a plurality of different update actions;
a first one of said different update actions is configured for causing an availability status of an e-mail account of the system user to be changed from a first e-mail availability status to a second e-mail availability status;
a second one of said different update actions is configured for causing an availability status of a voice mail account of the system user to be changed from a first voice mail availability status to a second voice mail availability status; and
a third one of said different update actions is configured for causing an availability status of an electronic calendar account of the system user to be changed from a first meeting availability status to a second meeting availability status.

6. The server of claim 1 wherein:
the information update rule defines a plurality of different update actions;
each one of said different update actions is configured for being provided to a respective one of a plurality of different secure information systems;
each one of said different secure information systems provides information communication in a different mode of communication than each other one of said secure information systems;
said instructions causing said at least one data processing device to cause said at least one update action to be implemented includes said instructions causing said at least one data processing device to cause each one of said different update actions to each be implemented by a respective one of said different secure information systems; and
said instructions causing said at least one data processing device to cause each one of said different update actions to each be implemented by the respective one of said different secure information systems includes said instructions causing said at least one data processing device to perform unidirectional transmission of information to each one of said different secure information systems.

7. A computer-readable medium having tangibly embodied thereon and accessible therefrom a set of instructions interpretable by at least one data processing device, said set of instructions configured for causing said at least one data processing device to carry out operations for:
receiving an information update command from a system user;
accessing an information update rule corresponding to the information update command, wherein the information update rule defines at least one update action;
accessing at least one secure information system on which the system user has an account; and
causing said at least one update action defined by the information update rule to be implemented by said at least one secure information system.

8. The computer-readable medium of claim 7 wherein causing said at least one update action to be implemented includes performing unidirectional transmission of information to said at least one secure information system.

9. The computer-readable medium of claim 8 wherein:
causing said at least one update action to be implemented includes causing a plurality of update actions defined by the information update rule to be implemented by said at least one secure information system.

10. The computer-readable medium of claim 7 wherein:
the information update rule defines a plurality of different update actions; and
causing said at least one update action to be implemented includes causing each one of said different update actions to each be implemented by a respective one of a plurality of different secure information systems.

11. The computer-readable medium of claim 10 wherein causing each one of said different update actions to each be implemented by the respective one of a plurality of different secure information systems includes performing unidirectional transmission of information to each one of said different secure information systems.

12. The computer-readable medium of claim 7 wherein the update rule is configured for implementing actions corresponding to one of:
the system user being absent for a prescribed number of days from a work environment that said at least one secure information system serves;
the system user arriving within a prescribed period of time at the work environment that said at least one secure information system serves.

13. The computer-readable medium of claim 7 wherein:
the information update rule defines a plurality of different update actions;
a first one of said different update actions is configured for causing an availability status of an e-mail account of the system user to be changed from a first e-mail availability status to a second e-mail availability status;
a second one of said different update actions is configured for causing an availability status of a voice mail account of the system user to be changed from a first voice mail availability status to a second voice mail availability status; and
a third one of said different update actions is configured for causing an availability status of an electronic calendar account of the system user to be changed from a first meeting availability status to a second meeting availability status.

14. The computer-readable medium of claim 7 wherein:
the information update rule defines a plurality of different update actions;
each one of said different update actions is configured for being provided to a respective one of a plurality of different secure information systems;
each one of said different secure information systems provides information communication in a different mode of communication than each other one of said secure information systems;
causing said at least one update action to be implemented includes causing each one of said different update actions to each be implemented by a respective one of said different secure information systems; and
causing each one of said different update actions to each be implemented by the respective one of said different secure information systems includes performing unidirectional transmission of information to each one of said different secure information systems.

15. A method, comprising:
at least one data processing device accessing, from memory coupled to said at least one data processing device, instructions causing said at least one data processing device to receive an information update command from a system user after passcode information of the system user is successfully verified;
said at least one data processing device accessing, from said memory, instructions causing said at least one data processing device to access an information update rule corresponding to the information update command, wherein the information update rule defines at least one update action;
said at least one data processing device accessing, from said memory, instructions causing said at least one data processing device to access at least one secure information system on which the system user has an account; and
said at least one data processing device accessing, from said memory, instructions causing said at least one data processing device to cause said at least one update action defined by the information update rule to be implemented by said at least one secure information system.

16. The method of claim 15 wherein:
the information update rule defines a plurality of different update actions; and
said instructions causing said at least one data processing device to cause said at least one update action to be implemented includes said instructions causing said at least one data processing device to cause each one of said different update actions to each be implemented by a respective one of a plurality of different secure information systems.

17. The method of claim 16 wherein said instructions causing said at least one data processing device to cause each one of said different update actions to each be implemented by the respective one of a plurality of different secure information systems includes said instructions causing said at least one data processing device to perform unidirectional transmission of information to each one of said different secure information systems.

18. The method of claim 15 wherein the update rule is configured for implementing actions corresponding to one of:
the system user being absent for a prescribed number of days from a work environment that said at least one secure information system serves;
the system user arriving within a prescribed period of time at the work environment that said at least one secure information system serves.

19. The method of claim 15 wherein:
the information update rule defines a plurality of different update actions;
a first one of said different update actions is configured for causing an availability status of an e-mail account of the system user to be changed from a first e-mail availability status to a second e-mail availability status;
a second one of said different update actions is configured for causing an availability status of a voice mail account of the system user to be changed from a first voice mail availability status to a second voice mail availability status; and
a third one of said different update actions is configured for causing an availability status of an electronic calendar account of the system user to be changed from a first meeting availability status to a second meeting availability status.

20. The method of claim 15 wherein:
the information update rule defines a plurality of different update actions;
each one of said different update actions is configured for being provided to a respective one of a plurality of different secure information systems;
each one of said different secure information systems provides information communication in a different mode of communication than each other one of said secure information systems;
said instructions causing said at least one data processing device to cause said at least one update action to be implemented includes said instructions causing said at least one data processing device to cause each one of said different update actions to each be implemented by a respective one of said different secure information systems; and
said instructions causing said at least one data processing device to cause each one of said different update actions to each be implemented by the respective one of said different secure information systems includes said instructions causing said at least one data processing device to perform unidirectional transmission of information to each one of said different secure information systems.
